(19) United States
(12) Patent Application Publication
(10) Pub. No.: US 2010/0237572 A1
(43) Pub. Date: Sep. 23, 2010

(54) Clamping Chuck

(76) Inventor: André Casel, Wuppertal (DE)

Correspondence Address: Scott R. Foster;Pandiscio & Pandiscio, 470 Totten Pond Road, Waltham, MA, 02451-1914, US

(21) Appl. No.: 12/224,012

(22) PCT Filed: Feb. 23, 2007
(86) PCT No.: PCT/EP2007/001597

§ 371 Date: May 27, 2010

(30) Foreign Application Priority Data
Feb. 23, 2006 (DE) 20 2006 003 096.4

(51) Int. Cl. B23B 31/107

(52) U.S. Cl. 279/82

(57) ABSTRACT

This invention relates to a clamping chuck for a machine tool driven in rotation. To provide a clamping chuck of this type with simple construction, in which in particular high-speed machine tools can be manufactured by simple means in miniature design with shaft diameters of only a few millimeters, so that they are easily replaceable on the one hand, and on the other hand are automatically held fast torsionally, it is designed so that a hollow cylindrical base member (2) has a round cylindrical cavity to hold a round cylindrical shaft (6) of the machine tool, and so that the clamping member (14) serves as a clamping device for the round cylindrical shaft (6) both axially and torsionally when the inner collar (13) of the sliding sleeve (7) stands in front of the wall gap (12), because of the fact that it extends into the internal round cylindrical cavity of the base member.

This invention relates to a clamping chuck for a machine tool driven in rotation pursuant to the preamble of the main claim.

Such clamping chucks are also called quick-clamp chucks because of the sliding sleeve used, by which the shaft of the machine tool, for example a tool holder, is held.

To change the tool, it is only necessary to move the sliding sleeve so that the clamping member on which the sliding sleeve acts is then freely movable within the wall gap where it rests.

This releases the shaft of the machine tool and it can then be easily withdrawn from the clamping chuck.

The objective of this invention is to provide a clamping chuck of this type with simple construction, in which in particular high-speed machine tools can be manufactured by simple means in miniature design with shaft diameters of only a few millimeters, so that they are easily replaceable on the one hand, and on the other hand are automatically held fast torsionally.

The invention reaches this objective with the features of the main claim.

The invention is distinguished by the fact that an inner collar of the sliding sleeve in the final position that it reaches under the action of spring force is in contact with the clamping member, which in turn exerts a correspondingly high lateral pressure on the round cylindrical shaft of the machine tool. Since the shaft of the machine tool, for example at the position where the clamping member rests, has a secantial groove or a secantial flattening, which of course does not go all the way around, clamping is also torsionally fixed when the clamping member rests on the flattening or the secantial groove.

The clamping member itself therefore has a double function. On the one hand, it secures the tool shaft axially, and on the other hand, because of the relatively low torques that attack the tool shaft, it also serves to block rotation. Furthermore, if the secantial groove in the axial direction dips to a lowest position, an axial force can also be exerted on the tool shaft down to a depth stop.

To this end, the shaft of the machine tool at the position in question advantageously has a hole, or a groove made only secantially, which is easier to produce, in which the clamping member engages when the sliding sleeve is moved in the direction of the exerted spring force.

The double function of the clamping member is combined with the round cylindrical bore in the base member, which makes possible a considerable simplification of handling.

This benefit is achieved by the clamping member dropping automatically into the secantial groove when the tool shaft rotates.

The base can also easily have an axial passage with a round cylindrical bore to hold the tool shaft, because the torque is transmitted through the clamping member.

A step to produce relatively high torques, as stated, is to make a secantial groove on the tool shaft.

Another step depends on the consideration that the clamping member rests on the tool shaft with a form fit, and consequently permits an initial rotational motion of the tool shaft until it drops into the secantial groove.

Therefore, a self-strengthening clamping action from suitable measures can also occur in the circumferential direction when the clamping member tilts correspondingly in the wall passage, for example.

As a last step, it would also be possible to design the inner collar of the sliding sleeve that rests against the clamping member outside of the wall gap in such a way that forceful clamping by the clamping member occurs with even a slight rotation of the tool shaft.

The double function is and remains important, of course, since the clamping member serves both to secure axially, and to secure in the direction of a possible rotational motion of the tool shaft.

The beneficial refinements are given in the subclaims.

Particularly with the usual machine tools with a thin tool shaft, about 3 mm to 4 mm, combined with the very high speeds of rotation of up to 30,000 rpm customary today, there are resonance vibrations in about the lower third of the tool shaft even with rigid clamping, which ultimately can lead to “singing” of the machine tool.

A refinement of the invention is helpful for this, in which the base member in the head area provides centering for the tool shaft. For example, this can be provided by the base member having an encircling inner groove on the insertion end into which a ring of elastomeric material is fitted.

The inside diameter of the fitted ring is slightly smaller than the outside diameter of the tool shaft, so that an additional radial clamping of the tool shaft is brought about here, with the help of which the freely vibrating length of the tool shaft is reduced between the point of engagement of the clamping member and the seat of the tool itself.

The amplitudes of vibration can be substantially reduced thereby, while the natural frequencies are raised at the same time.

The unwanted erratic running of the machine tool because of the feared natural frequencies is therefore reliably avoided.

The invention will be described in further detail below with reference to examples of embodiment.

The Figures show:

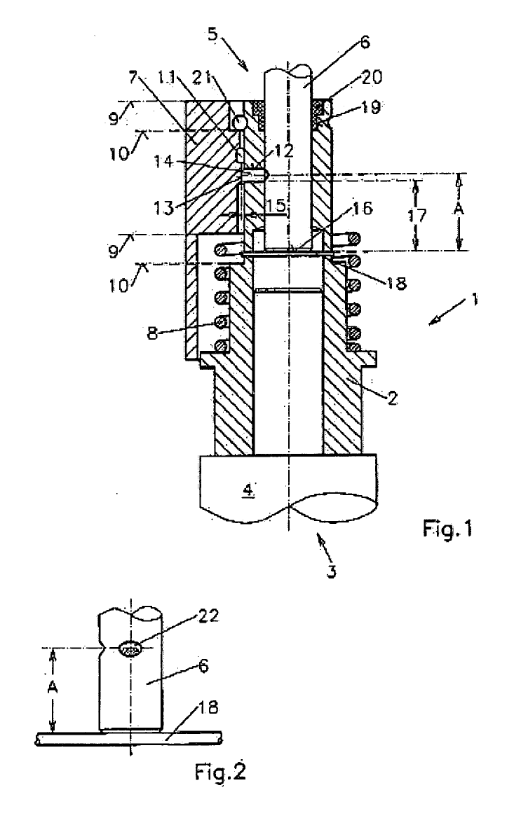

FIG. 1 a first example of embodiment of the invention in longitudinal section;

FIG. 2 a possible example of embodiment of an associated tool shaft;

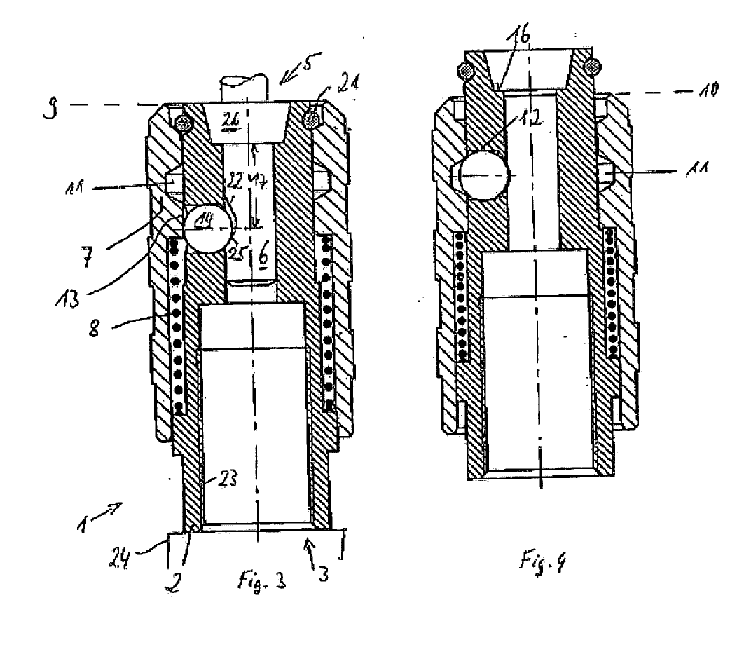

FIG. 3 another example of embodiment of the invention in operating position; and

FIG. 4 the example of embodiment of FIG. 3 in inserted position.

If not otherwise stated below, the following description applies to all of the Figures.

The figures show a clamping chuck 1 for a machine tool driven in rotations.

The machine tool is not shown. Only the shaft 6 of the machine tool is shown.

The clamping chuck has a central hollow cylindrical base member 2. The base member 2 has a drive end 3 for the machine spindle 4 and an opposite insertion end 5 for the shaft 6 of a machine tool.

The base member 2 is surrounded by a sliding sleeve 7 that, in this case, is under spring toward the insertion end 3.

The sliding sleeve 7 can also be under spring load in the other direction. The following discussions apply appropriately to this case.

The spring load is applied by a compression spring 8 that is supported between an outer collar of the base member 2 and an inner shoulder of the sliding sleeve 7.

The sliding sleeve can move between a forward final position 9 and a rear final position 10.

It has an encircling inner groove 11 that is aligned with a wall gap 12 in the base member 2 in the end position 10 predetermined by the compressed compression spring 8.

There is a clamping member 14 in the wall gap 12, whose radial dimensions are larger than the thickness of the base member 2 at the point of the wall gap 12.

A radial clearance 15 also has to be taken into consideration when appropriate, which is produced between the inner collar 13 of the sliding sleeve 7 and the outside diameter of the base member 2 at the point of the wall gap 12.

The inner collar 13 is located on the sliding sleeve 7 at a point that is opposite the wall gap 12 in the forward end position 9 of the sliding sleeve 7 when the sliding sleeve is under the load of the compression spring 8.

Thus, the clamping member is inescapably held in the secantial groove 22 of the tool shaft.

It is important for the hollow cylindrical base member 2 to be hollow in round cylindrical shape on the inside, especially in the longitudinal area in which the shaft 6 of the machine tool is seated, so that it is designed to accept a round cylindrical shaft 6 of the machine tool.

The inside diameter of this round cylindrical hollow therefore corresponds to the outside diameter of the round cylindrical shaft of the machine tool, so that the shaft 6 in principle can rotate freely in the bore in the base member 2.

Furthermore, the clamping member 14 in the position of the sliding sleeve 7 in which the inner collar 13 is supported on the clamping member 14, or in which the inner collar 13 of the sliding sleeve 7 is aligned with the wall gap 12, serves as both an axial a torsional clamping device of the round cylindrical shaft 6 of the machine tool, because the shaft of the machine tool has the secantial groove at a suitable position.

The clamping member 14 therefore has a double function.

On the one hand, it prevents the shaft 6 of the machine tool from dropping out axially, while at the same time it also provides a clamping function in the circumferential direction.

It is important here for the wall gap 12 to be at a given distance 17 from a depth stop 16 against which the front face of the inserted shaft 6 strikes in the embodiment according to FIG. 1.

Specifically, the secantial groove can then be designed with a tapered flank at a point at which the clamping member 14 arrives when the shaft 6 of the machine tool rests against the depth stop. The axial clamping function is thereby guaranteed.

Namely a clamping of the shaft 6 in the central area is achieved in this way, so that despite the unavoidable radial clearance of the tool shaft 6 in the round cylindrical bore of the base member 2 because of the necessary transition fit, free vibrations can occur only conditionally.

Specifically, a clamping point of the shaft 6 occurs from the clamping member 14 that is displaced toward the center of the shaft, so that any resonance vibrations that occur have only small amplitudes and above all, only at high frequencies.

The distance 17 provided for, which determines the spacing for the clamping member between the depth stop 16 and the clamping point of the shaft 6, therefore also serves the purpose of reducing the free length of the shaft 6 participating in any resonance vibrations.

In the case of FIG. 1, the depth stop 16 is composed of a pin 18 passing transversely through the base member 2.

The pin is located in front of the head end of the machine spindle 4 and is seated in a radial bore passing transversely through the base member 2.

When the shaft 6 is inserted, its forward face strikes the transverse pin 18 at any time and can then be rigidly held axially and circumferentially by the clamping member 14 letting go of the sliding sleeve 7 as soon as the clamping member has dropped into the secantial groove.

Since the sliding sleeve 7 in this end position is also held against the upper lock ring 21 by the compression spring 8, the shaft 6 is clamped with operational security.

The lock ring 21 can also be identified by color to signal whether the sliding sleeve 7 is fully extended.

In addition, if it is desired to reduce even further the free vibrational length of the inserted shaft 6, an encircling inner groove 19 can be provided at the head end of the base member 2 in which a ring of elastomeric material is laid.

This ring on the one hand has good damping properties and can also have an inside diameter that is slightly smaller than the outside diameter of the shaft 6.

This applies equally to the round cylindrical hollow in the base member 2 into which the shaft 6 of the machine tool is inserted.

Because the enclosure of the shaft 6 is then elastic but free of play at the point closest to the tool, the lengthwise dimensions of the shaft 6 that may participate in free vibration are further reduced, and consequently the amplitudes are reduced and the frequencies are raised.

The elastomeric ring 20, for example, can consist of rubber or silicone or similar material.

Instead of the elastomeric ring, a centering device in the form of a spring chuck or steel springs or the like can be provided at this point. A conical seat that constitutes a centering cone 26 corresponding to FIGS. 3 and 4, in which a tool shaft of complementary design is seated, is also practical. The conical seat in this case also constitutes the depth stop 16 at its point of smallest diameter. This refinement is especially practical with shaft diameters larger than 3 mm to 4 mm, for example 6 mm to 12 mm or larger.

FIG. 2 also shows a detailed view of a shaft 6 that is impacted by the clamping member 14 at a given distance A from the front face of the insertion end.

The distance A here is measured from the tangent line of the pin 18 that limits the depth of insertion of the shaft 6 into the clamping chuck 1 to the point at which the clamping member 14 impacts the shaft 6.

To produce especially high torsional clamping, it is suggested that such a tool shaft 6 be provided with at least one groove 22 that runs over only part of the circumference, so that the clamping member 14 that is held in clamping position by the inner collar 13 actually exerts a clamping action on the shaft 6 in the circumferential direction that leads to torque-resistant clamping.

The clamping member is pressed against the inner collar 13 in the circumferential direction when the shaft 6 rotates, and is pressure-loaded in this way. Since the clamping member 14 cannot have any radial excursion, the necessary clamping function in the circumferential direction is assured.

The inner collar 13 in this case prevents a radial excursion of the clamping member toward the outside, so that the torque exerted by the machine spindle 4 is fully transferred to the shaft 6 of the machine tool through the clamping function of the clamping member 14 in the circumferential direction.

If the clamping member 14 additionally grips a downward slope 25 of the secantial groove 22, the axial clamping is also unalterably firm. This is feasible in the hatched area of the secantial groove 22 in FIG. 2.

### LIST OF REFERENCE SYMBOLS

1 Clamping chuck
2 Base member
3 Drive end
4 Machine spindle
5 Insertion end
6 Machine tool shaft
7 Sliding sleeve
8 Compression spring
9 Forward end position
10 Rear end position
11 Inner groove
12 Wall gap
13 Inner collar
14 Clamping member
15 Radial clearance
16 Depth stop
17 Spacing
18 Pin
19 Inner groove
20 Elastomeric ring
21 Lock ring
22 Groove
23 Inner thread
24 Machine spindle
25 Downward slope
26 Centering cone
A Distance

What is claimed is:

1. A clamping chuck (1) for a rotationally driven machine tool, said chuck comprising a central round hollow cylindrical base member (2) having a drive end (3) comprising a machine spindle (4) and an opposite insertion end (5) comprising a shaft (6) of the machine tool; the base member (2) being encircled by a sliding sleeve (7) that is spring-loaded (8) in one direction; the sliding sleeve (7) being movable between two end positions (9, 10); the sliding sleeve (7) having an encircling inner groove (11) where an inner wall of the sliding sleeve closes a wall gap (12) in the base member (2) in the end position (10) that is reached in the direction opposite to the spring load (8), and an encircling inner collar (13) is aligned with the wall gap (12) in the end position (9) that is reached in the direction of the spring load (8); a clamping member (14) is seated in the wall gap (12) whose radial dimension is larger than the wall thickness of the base member (2) at the point of the wall gap plus any radial clearance (15) between the inner collar (13) of the sliding sleeve (7) and an outside diameter of the base member (2), wherein the hollow cylindrical base member (2) has an internal circular cylindrical cavity to hold a round cylindrical shaft (6) of the machine tool and the clamping member (14) serves as a clamping device for the round cylindrical shaft (6) both axially and torsionally when the inner collar (13) of the sliding sleeve (7) is adjacent the wall gap (12), because the clamping member (14) extends into the internal round cylindrical hollow of the base member (2).

2. Clamping chuck (1) pursuant to claim 1, wherein the wall gap (12) is spaced from a depth stop (16) of the clamping chuck (1) at a given distance (17) from the depth stop (16).

3. Clamping chuck (1) pursuant to claim 2, wherein the depth stop (16) comprises a pin (18) passing transversely through the base member (2) that is positioned at a head end of the machine spindle (4).

4. Clamping chuck (1) pursuant to claim 2, wherein the depth stop (16) comprises a diametrical shoulder in the base member (2).

5. Clamping chuck (1) pursuant to claim 1, wherein the base member (2) at its insertion end (5) is provided with an encircling inner groove (19) in which is disposed a ring (20) of elastomeric material.

6. Clamping chuck (1) pursuant to claim 5, wherein an inside diameter of the ring (20) of elastomeric material is slightly smaller than the round cylindrical hollow in the base member (2) for the shaft (6) of the machine tool.

7. Clamping chuck (1) pursuant to claim 1, wherein the base member (2) at its insertion end (5) is provided with a centering cone (26).

8. Clamping chuck (1) pursuant to claim 1, wherein the base member (2) has an inner thread at the drive end for the machine spindle.
